(19) United States
(12) Patent Application Publication
(10) Pub. No.: US 2002/0060269 A1
(43) Pub. Date: May 23, 2002

(54) Lift-providing unit for levitating a platform

(76) Inventor: Norman V. Robinson, Brooklyn, NY (US)

Correspondence Address: BIERMAN, MUSERLIAN AND LUCAS, 600 THIRD AVENUE, NEW YORK, NY, 10016, US

(21) Appl. No.: 09/973,679

(22) Filed: May 23, 2001

Related U.S. Application Data
(63) Continuation of application No. 08/650,063, filed on May 17, 1996, now abandoned.
Application No. 08/650,063 is a continuation-in-part of application No. 08/582,164, filed on Jan. 2, 1996, now abandoned.
Application No. 08/582,164 is a continuation-in-part of application No. 08/215,164, filed on Mar. 21, 1994, now abandoned.
Application No. 08/215,164 is a continuation of application No. 07/947,781, filed on Sep. 18, 1992, now abandoned.

(51) Int. Cl. B64C 27/00; B64C 39/00

(52) U.S. Cl. 244/62

(57) ABSTRACT

A lift-providing unit including two weight units disposed at opposite ends of a rotating armature, at least one of the weight units being capable of generating a recoil force. Lift is provided by the recoil force multiplied by the centripetal force of the rotating armature.

### CROSS-REFERENCE

This is a continuation-in-part of patent application Ser. No. 08/582,164 filed Jan. 2, 1996, which in turn was a continuation-in-part of patent application Ser. No. 08/215,164 filed Mar. 21, 1994, now abandoned, which in turn was a continuation of patent application Ser. No. 07/947,781 filed Sep. 18, 1992, now abandoned.

### BACKGROUND OF THE INVENTION

1. Field of the Invention

This invention relates to a unit for generating lift for lifting a platform, more specifically to a lift-generating unit that uses a recoil, amplified by a centripetal force, to lift a platform upon which the unit is attached.

2. Prior Art

Flight has been known for centuries. Birds have long used it as a means for migration, hunting and seeking shelter. Humans have been fascinated with air travel. However, it has only been in our recent past that humans have produced machines capable of sustained flight, e.g., airplanes, helicopters, rocket ships and Hovercraft. These flying machines generate lift using rotors, propellers, compressed gas or compressed liquid. For example, lift in hovering vehicles is supplied by compressing air from below the vehicle using a rapidly rotating rotor and allowing the compressed air to generate lifting of the vehicle. Such a device has the shortcoming in that it cannot generate lift in a vacuum, e.g., outer space.

Machines that do generate lift in vacuums typically expel gases through a port located in the bottom of the vehicle. There is a need for other methods of generating lift in a vacuum. Additionally, there is always a need for finding new ways for man to fly.

### SUMMARY OF THE INVENTION

This invention satisfies the above needs. A novel lift-generating unit for generating lift in a vacuum has now been discovered. The lift-generating unit of the present invention uses a rotating armature with a movable plunger mounted thereon. Lift is produced by coupling the forces generated by rotating the armature while simultaneously moving the plunger during rotation. In one embodiment, recoil force, generated by moving the plunger, is amplified by centripetal force, generated by rotation of the armature, to provide lift. In another embodiment, referred to as induced unbalanced action herein, impact force, generated by moving the plunger, in conjunction with centripetal force, generated by rotating the armature is used to provide lift. The difference between recoil force and impact force is essentially the position of the plunger and the direction in which the plunger is moved during rotation of the armature.

In both embodiments, an armature which rotates about a horizontal axis is used to provide the centripetal force while a movable plunger mounted on the armature is employed to provide the recoil/impact force. The armature rotates in a vertical plane. A frame with a horizontally oriented axle provides the horizontal axis and support about which the armature rotates.

In order to provide a recoil force, the plunger is moved in a downwardly vertical direction during rotation. To provide a recoil force during the top half of rotation, the plunger is moved from a position away from the axis to a position near the axis. To provide a recoil force during the bottom half of rotation, the plunger is moved from a position near the axis to a position away from the axis. The top half of rotation being between about 270° and 90°, assuming a clockwise rotation with 360°/0° at the top; and the bottom half of rotation being betweem about 90° and 270°, assuming clockwise rotation and 360°/0° at the top.

The recoil force can be generated either during only one half of the rotation or during both halves of the rotation. In any event, the plunger should always be positioned away from the axis during the bottom half of rotation and near the axis during the top half of rotation. It will be understood that the actual distance between the axis and the plunger will vary and that near the axis does not mean next to the axis.

In order to provide impact force, the plunger is moved in an upwardly vertical direction during rotation. To provide an impact force during the top half of rotation, the plunger is moved from a position near the axis to a position away from the axis. To provide an impact force during the bottom half of rotation, the plunger is moved from a position away from the axis to a position near the axis. The top half and bottom half of rotation being defined as above.

The impact force can be generated either during only one half of the rotation or during both halves of the rotation. In any event, the plunger should always be positioned near the axis during the bottom half of rotation and away from the axis during the top half of rotation.

It is preferred that more than one plunger can be employed in the present invention. Where a plurality of plungers are employed, the plungers are positioned equiangular about the axis and are positioned in a common vertical plane. Preferably, there are an even number of plungers and, more preferably, either 2 or 4 plungers.

### BRIEF DESCRIPTION OF THE DRAWINGS

These and other features, aspects and advantages of the present invention may be better understood with reference to the following drawings wherein:

FIG. 1 shows a sectional view of a preferred embodiment of the invention;

FIG. 2A shows a sectional side view of another preferred embodiment of the invention;

FIG. 2B shows a perspective view of the center cam of the preferred embodiment in FIG. 2A;

FIGS. 3A and 3B show perspective views of alternative embodiments of the center cam in FIG. 2B;

FIG. 4 shows a cutaway side view of a vehicle incorporating another preferred embodiment of the invention wherein the lift-generating device is used to supply both lift and to provide directional movement in a modified form;

FIG. 5 shows a sectional view of another preferred embodiment of the invention; and

FIG. 6 shows a sectional view of another preferred embodiment of the present invention.

### DETAILED DESCRIPTION OF THE INVENTION

The present invention is directed to a lift-generating unit having a plunger for generating recoil/impact energy which is multiplied by the simultaneously supplied centripetal force to generate lift.

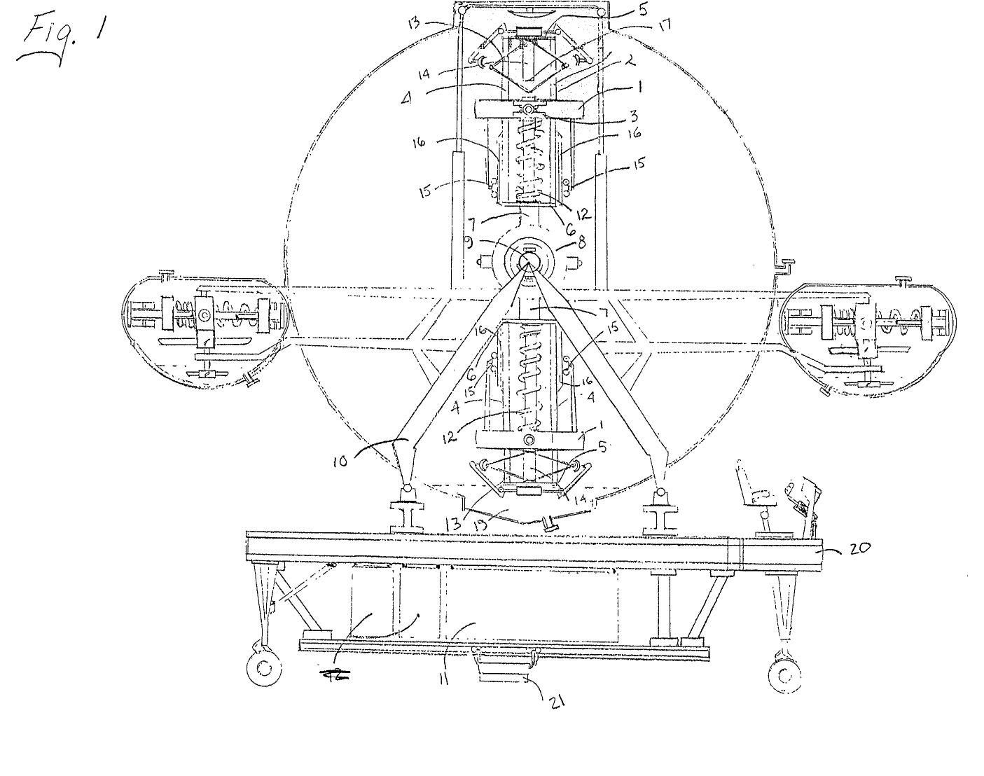

Turning now to the embodiment of FIG.1, this embodiment utilizes an electromechanical arrangement for the recoil device. To accomplish this, recoil generating devices are disposed at opposite ends of a revolving armature. For levitation, each recoil generating device is activated when it is in the downward position of the armature rotation to generate a downward force, causing an equal and opposite lifting force. This lifting force is multiplied by the centripetal force of the spinning armatures. By continuously firing the recoil devices, each time one of the recoil devices is in the downward position, lift can be maintained.

Referring to FIG. 1, there is shown an inventive lift-providing unit in which the recoil device comprises an electromechanical arrangement. Each recoil device comprises a pair of weight plates 1 (plungers) in which two opposing magnetic coils are disposed. These opposing coils comprise protracting coil 2 and retracting coil 3. Each weight plate is mounted so that it rides on guide shafts 4 which pass through corresponding fenestrations in weight plate 1. The guide shafts 4 ate mounted between upper base plate 5 and lower base plate 6 and each weight assembly is centered around opposite ends of armature 7. At the center of armature 7 is a rotating stator 8 that revolves around a fixed rotor 9. Rotor 9 is mounted on support bracket 10 and is powered by a power source such as batteries 11. The spinning of armature 7 around rotor 9 supplies the required centripetal force.

Mounted between lower base plate 6 and weight plate 1, concentric to armature 7 is coil spring 12. When retracting coil 3 is energized, it retracts weight plate 1, against the force of coil spring 12 and maintains weight plate 1 in the retracted position until triggered. Protracting coil 2 and retracting coil 3 are positioned in weight plate 1 so as to have little or no inductive effect on each other. A recovery spring 13 is mounted between weight plate 1 and upper base plate 5 to maintain a position of weight plate 1 after firing, and before retraction, and to further limit the travel of weight plate 1 so that upper base plate 5 is not contacted by weight plate 1. Further limiting travel is protracting armature 14. Each weight assembly is provided with movable electric contact brushes (or rollers) 15 which are in sliding contact with stationary conduction rails 16. The combination of the movable contact brushes 15 and stationary conducting rails 16 supplies electricity to either of protracting coil 2 or retracting coil 3, when needed. Sensor 17 is provided in protracting armature 14 to sense when weight plate 1 has reached the outer engaging limit.

The spinning armature and weight assembly are housed within fairing 18. At the bottom portion of fairing 18 is supplied a lubrication reservoir 19 which keeps the mechanism lubricated. The entire unit is attached to platform 20. Sliding weight 21 is affixed to platform 20 to maintain a horizontal attitude during travel. Steering for the platform can be provided by any means, but preferably, a modified version of the inventive recoil unit can be used. This recoil unit, as shown in FIG. 1, is similar to that used to levitate the platform. Thus, only the recoil energy of the weight plate is used to supply a forward, backward and side to side motion. The direction of the recoil unit can be controlled by a pilot to direct the recoil unit so that it is in a direction opposite to that in which the platform is to be moved. Steering and electrical controls can be positioned on platform 20.

In use, power is applied to the windings of stator 8, thus producing a field flux which causes armature 7 to rotate. Assuming that each weight plate 1 weighs 200 pounds, the armature can be rotated at a speed at which each of the weight plates displays an apparent weight of 4,500 pounds, due to the artificial gravity generated by centripetal acceleration. These numbers are, of course, used as an example.

Due to the rotation of armature 7 and the centripetal acceleration generated thereby, weight plates 1 will move away from the center axis of armature 7 collapsing recovery springs 13. A sensing device mounted on support 10 registers each rotation of the armature to provide a timing control circuit so that for each revolution, either protracting coil 2 or retracting coil 3 can be fully or partially electrically energized as needed. Protracting coil 2 and retracting coil 3, can thereby be used to control the amount of force generated by the movement of weight plate 1, controlling the amount of lift applied to platform 20.

Once centripetal acceleration is established by the rotation of armature 7, an electronic timing control is activated each time armature 7 passes a position substantially perpendicular to a horizontal plane in which the axis of rotation is contained. Protracting coil 2 in the weight assembly in the downward position is, at that point, energized, propelling weight plate 1 in a downward position against the force of coil spring 12. Simultaneously, retracting coil 3 in the upwardly pointing weight assembly is activated, pulling weight plate 1 toward the center of rotation to provide additional lift. Thus, both weight plates are simultaneously moved in a downwardly, vertical direction. This downwardly, vertical force, in turn, generates a recoil force, which provides lift. Using the numbers described above, the weight assembly at the top will displace 4500 pounds, while that of the bottom is removing 4500 pounds. This procedure therefore generates a lift of 9000 pounds around the axis of rotation for that fraction of a second. Since both weight plates 1 generate approximately the same force, before firing, no torque is generated around the axis of rotation. The foregoing process is repeated each half rotation and, due to the high rate of revolution of the armature, the lift applied by the two opposing weight assemblies can be maintained. By controlling the amount of power directed to the protracting and retracting coils, the amount of lift can be controlled.

In addition to recoil action, some lift can also be generated by induced unbalanced action (impact force). Such action may be figuratively explained as follows. The armature traverses a circle during rotation, dividing the circle in half with a horizontal line, forms an upper portion, the positive half, and a lower portion, the negative half. Transposing this upon the lift-generating unit depicted in FIG. 1, whenever weight plate 1 enters the positive half of the circle, it is fully extended and whenever weight plate 1 enters the negative half, it is fully retracted about its axis of rotation. Such a position of the weight plates causes an unbalanced condition. Weight plate 1 is heavier at the fully extended position than it is at the retracted position. This being the case, the heavier weight plate 1 will always be in the positive half and the lighter weight plate will always be in the negative half, thereby generating lifting in the positive half. This induced unbalanced action is also multiplied by centripetal force. Thus, there are two differences between lift produced by recoil action and that by induced unbalanced action. First, the recoil force produces a much more powerful lift than the lift produced by an unbalanced action. Second, the angle of firing is almost vertical in the recoil force and almost horizonal for the unbalanced action. Induced unbalanced action is available for emergency landings in the event that full power is not available, thus induced unbalancing acts as a form of autorotational landing.

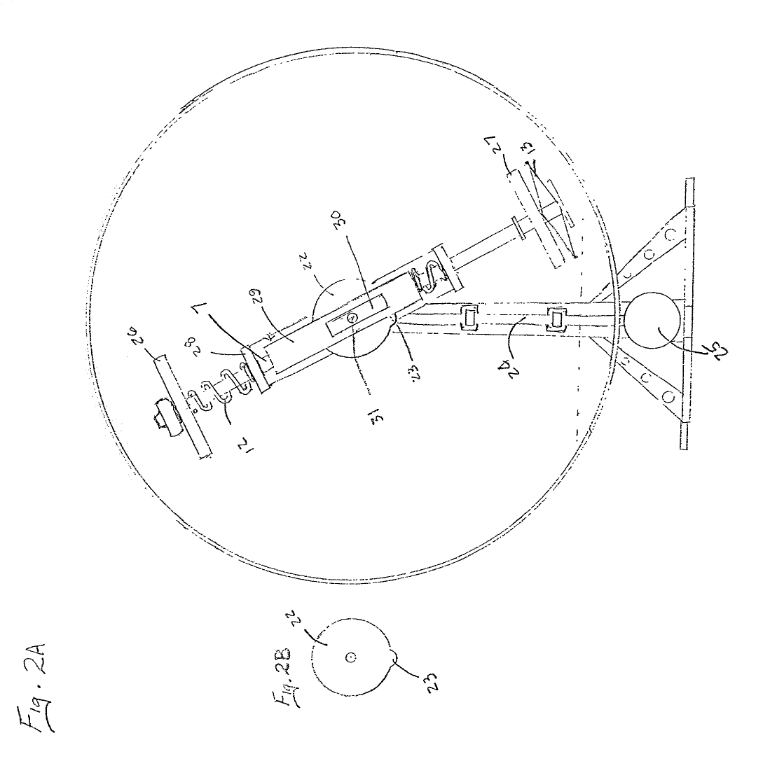

A fully mechanical version of the inventive lift providing device is illustrated in FIG. 2A. This apparatus operates under the same principle, as above, in which two equally balanced weights are rotated at a velocity, both weights being rapidly moved in a downward position to generate an opposite upward thrust reaction, or recoil, to generate lift. Thereafter, before the weight has an opportunity to complete the downward journey, the two weights are instantaneously revolved so that they are again propelled downward; repeating this operation continuously to generate a recoil force and a continuous lift generated around an axis of rotation.

In the mechanical version of the invention, a cam assembly is employed. Cam 22 is shown in FIG. 2B and is substantially round, with a single protrusion 23 on the surface thereof. The cam is attached to a drive mechanism 24 which is in turn connected to a motor 25 for applying rotation to armature 7. Unlike the electromechanical device shown in FIG. 1, the two weight assemblies of the fully mechanical embodiment of the invention are not identical. Instead, a first weight assembly acts as a lifting weight assembly 26 while the other comprises an equalizing weight assembly. The lifting weight assembly is suspended above lifting base 28 by coil spring 12. Equalizing weight assembly 27 and lifting weight assembly 26 are connected by bridging member 29 which has an elongated opening 30 which allows the entire armature 7 to slide along central shaft 31 when protrusion 23 on cam 22 is contacted.

The impact between bridging member 29 and protrusion 23 causes lifting weight assembly 26 to be propelled downward against the force of coil spring 12 while, at the same time, being equalized by the downward motion of equalizing weight assembly 27 against recovery spring 13. Thus, both weight assemblies are propelled by the contact of the single protrusion 23 on cam 22. The downward force of the two weight assemblies generates an equal and opposite upward recoil force which, when multiplied by the centripetal force of the spinning armature 7 generates sufficient lift to levitate a platform to which the device is attached. The lifting weight assembly is mounted solidly to the shaft while the equalizing weight assembly moves concentric thereto.

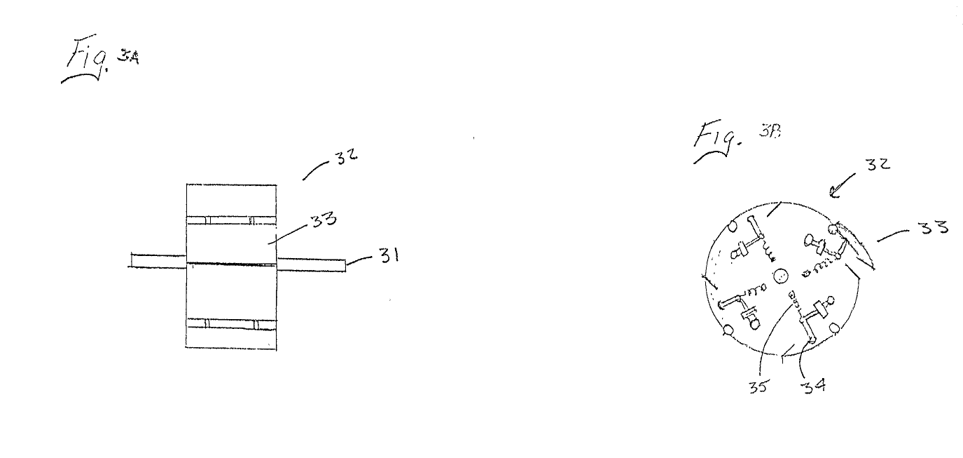

The cam of FIG. 2A can also be replaced by the mechanism shown in FIGS. 3A and 3B. This device allows deflection of the weight assemblies in more than one direction and therefore can provide, in addition to lift, a means for moving the platform laterally. While cam 22 has a single protrusion 23, a deflector 32, as shown in FIGS. 3A and 3B, is completely round and is provided with doors 33 controlled by mechanical levers 34 which are, in turn, connected to a cable system attached to a control stick (not shown). Each door and control lever has a return spring 35 which will close a door when cable pressure is released. By controlling which door is opened, the direction of recoil can be controlled, causing a change in the direction in which the platform is propelled. In all other respects, this embodiment of the invention operates in the same manner as that shown in FIG. 2A.

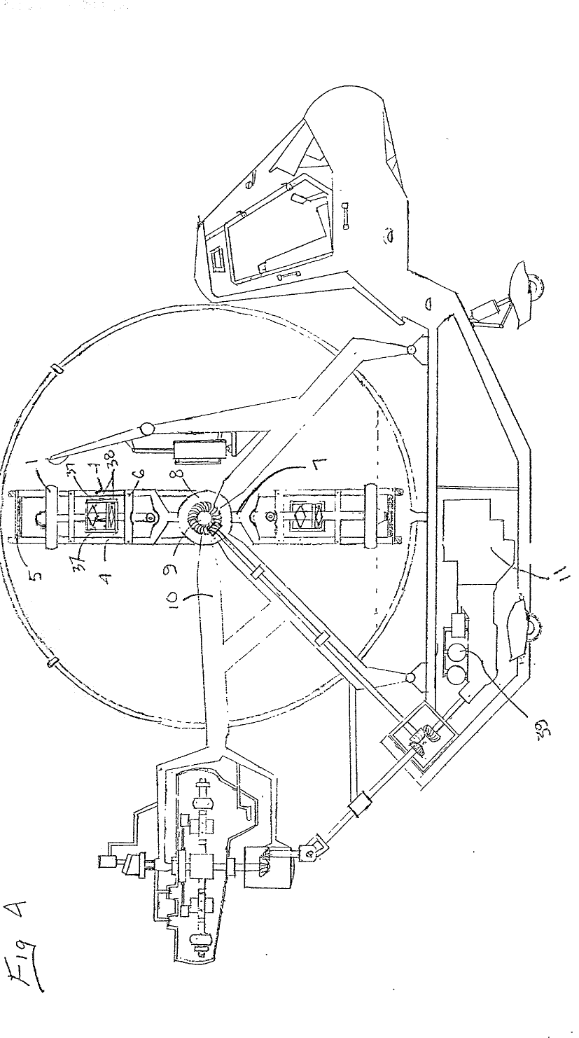

FIG. 4 illustrates an embodiment of the invention wherein deflection of weight plate 1 is powered by compressed air. The air unit includes air cylinder 37 and elliptical springs 38. Motor 11 drives a gear shaft which in turn rotates armature 7. Compressed air for operating air cylinders 37 is supplied from a compressed air reservoir 39. Except for the manner in which force is applied to weight plate 1, this unit operates using the same basic principles as supplied in the embodiment illustrated in FIG. 1. Each air cylinder is provided with four air valve switches secured to each of the cylinders and are connected through a pushrod to a cam that is fixed to the air frame. The cam can have a notch area and the opposite side thereof a serrated area. When a pushrod strikes the notch area and the other one falls into the serrated area of the cam, the cam is positioned so the notch and serrated area are perpendicular. When the pushrod strikes the high point of the cam, the top valve opens at the top half of the cylinder letting in compressed air and simultaneously, the bottom valve opens, venting compressed air from the cylinder at the upper position. The two elliptical springs hold the weight plate in position so they do not move up and down upon their shafts.

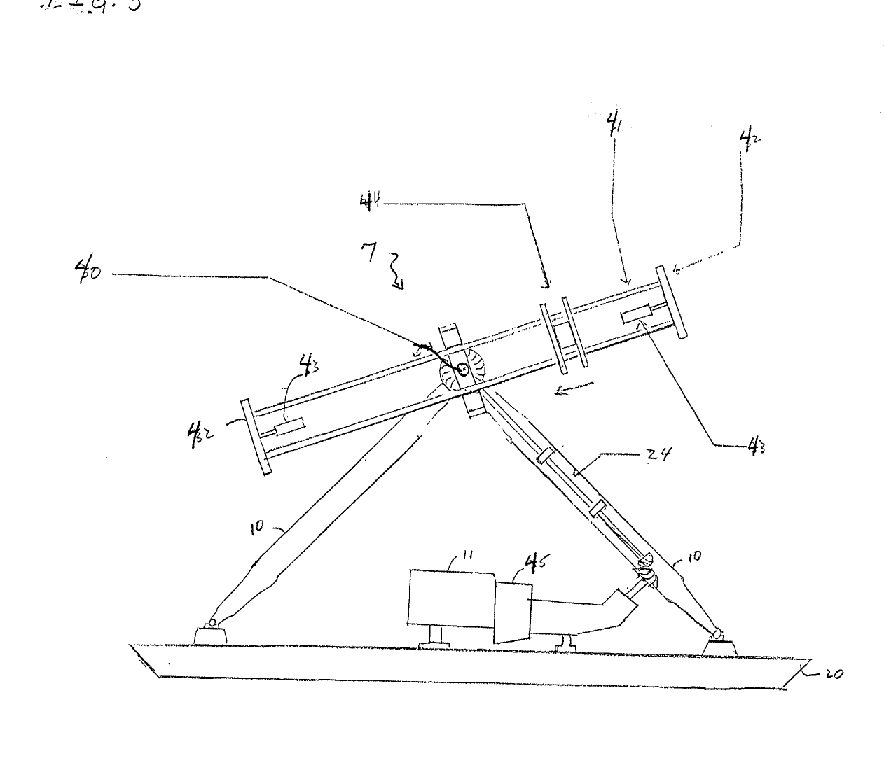

FIG. 5 illustrates another preferred embodiment of the invention wherein armature 7 rotates about axis 40 and comprises electrically conductive elongated rods 41 which are supported above platform 20 by support means 10. Rods 41 are parallel to one another and electrical insulator 42 is affixed to each end of rods 41. Solenoid core 43 is attached to electrical insulator 42. Weight plate 44 slides on rods 41. Weight plate 44 has a solenoid coil mounted therein and moves between the two ends of rods 41. Weight plate 44 has a hole therein in which the solenoid coil is positioned and which allows weight plate 44 to completely cover solenoid core 43 when weight plate 44 is at one end or the other end of rods 41. Motor 11 is connected to gear box 45 which in turn is connected to drive mechanism 24, as shown, to cause rotation of armature 7 about axis 40.

The rotation should begin slowly so that the unbalancing effects of the coil at one extreme end of the unit is reduced to a minimum.

Once rotation has begun, the electric firing timer (not shown) is activated. Each time rods 41 approach the complete horizontal axis, approximately 80° to 88°, but no more than 90°, the drive unit 44 is at the right side of rods 41 and abutting insulator 42 and covering solenoid core 43. Electricity is then provided to rods 41 which energizes the solenoid coil of weight plate 44 through electrical contact, thereby sending the weight plate 44 rapidly along rods 41 to the other end. Weight plate 44 then makes contact with the left side of armature 7 which is now at approximately 275° to 280°. Once the weight plate 44 completes contact, a centripetal force acting on weight plate 44 generates weight in the upper half of the cycle of rotation, thereby making an upward lift component through the rods 41 and to the complete unit. This operation continues with ever increasing speed until the desired lift is reached. Preferably, the drive unit must never complete a single revolution because it may counteract the lifting force generated. Further, it is possible to reduce vibration and generate greater lift using two single action decentralizers attached to the same base adjacent to each other displaced 90° apart with a spontaneous firing order. In this way the unbalanced action (impact force) as referred to above can be used to provide lift.

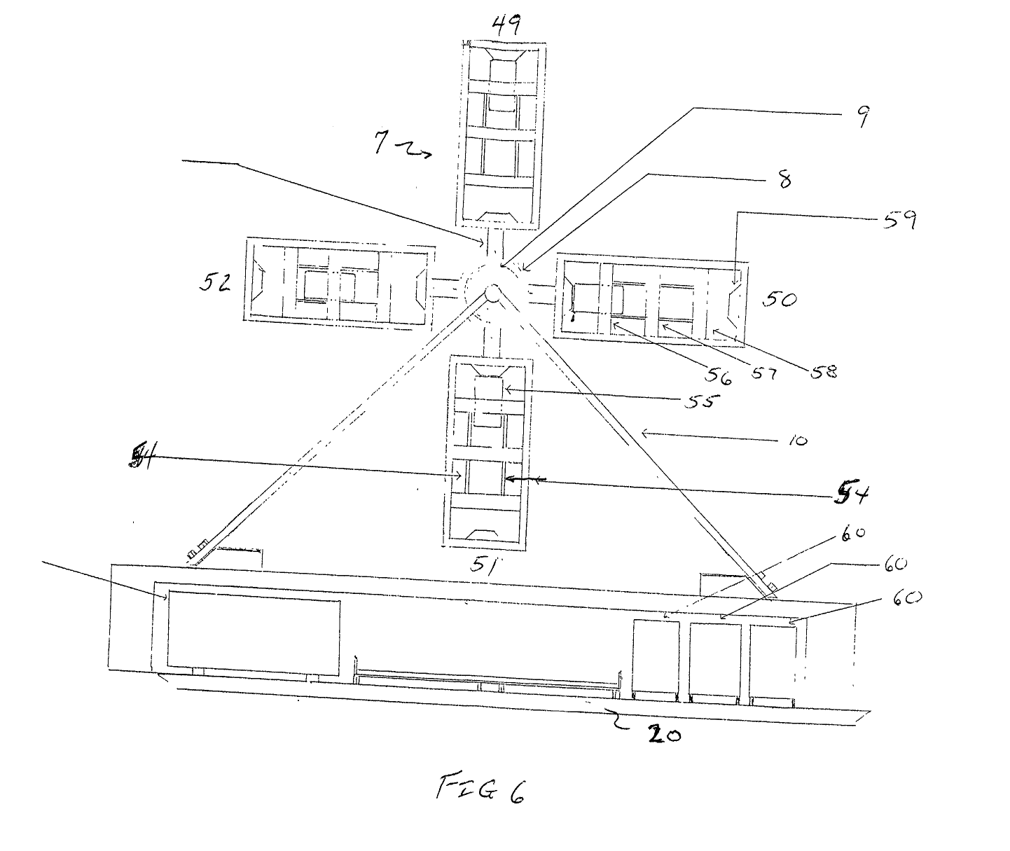

FIG. 6 illustrates another preferred embodiment of the invention wherein controlled unbalanced action (impact force) is used to generate lift. Lift is provided as the result of three phenomenon, centripetal force, recoil force, and impact force. To achieve controlled unbalanced action in accordance with the embodiment shown in FIG. 6, armature 7 is divided into a plurality of elongated armature assemblies 49, 50, 51 and 52. Each assembly is attached to rotating stator 8. Stator 8 rotates about fixed rotor 9 which is mounted on support means 10 above platform 20.

Each assembly comprises guide tubes 54, preferably constructed of non-magnetic material, which define a channel through which plunger 55 travels. The guide tubes allow plunger 55 to travel from one end of the assembly to the other end in response to electromagnetization. Positioned about tubes 54 are stationary solenoid coils 56, 57, and 58. An electric motor (not shown) is employed with rotating stator 8 and rotor 9. At each end of the assembly is stopper 59 to protect the assembly from damage caused by high impact of plunger 55.

The plurality of assemblies are spaced equiangular about their axis of rotation, rotor 9. Preferably, an even number of assemblies are employed in the present invention. More preferably, at least two and, more preferably, at least four assemblies are employed in the present invention.

The unit shown in FIG. 6 operates as follows.

The armature rotates in a clockwise direction by electrically energizing and de-energizing each solenoid coil in a spontaneous order to propel the plunger. When the assemblies approach or pass into the bottom (negative) half of its rotation, plunger 55 is moved to the center of rotation. Simultaneously, the solenoid coils in the assemblies in the top (positive) half of the rotation become de-energized, thereby employing centripetal force to move the plunger onto the outer stopper in the assembly to generate a centripetal lift component. The solenoid coil 56 keeps plunger 55 at the center of rotation during the negative half of rotation of the assembly, while de-energizing the solenoid allows plunger 55 to rest against the outer stopper during the positive half of rotation of the assembly. This action is repeated over and over again to generate lift. Alternatively, this action can occur in a counter-clockwise direction. As is evident to one of skill in the art, this arrangement can also be used to generate lift through recoil force by reversing the movement of the plunger using the solenoid coils.

To keep the plungers in balance during start-up, the solenoid moves the plungers out against the outer stopper until the revolutions per minute build up. Then normal spontaneous deflection takes place to generate unbalanced action and lift. Electric firing device 60 times the spontaneous coil energizer with rotation and also detects the plunger's position. The electrical power of the coils is proportional to the speed of rotation, that is, as the speed increases, so does the electrical power.

Spontaneous coil firing is an important aspect. For example, when the unit is rotating, artificial gravity is generated on each plunger, thereby placing them against the outer stopper. Upon starting the firing system, coil 58 on the assembly entering the negative half, is turned on first, and when it centers the plunger, i.e. plunger is in the center of coil 58, coil 57 instantaneously senses the plunger's position and comes on, simultaneously turning off coil 58. Once coil 57 centers the plunger, coil 56 senses it and turns on and simultaneously turns off coil 57. Once coil 56 centers the plunger, it holds the plunger against the inner stopper until the assembly revolves into the positive half where the plunger is released. The above-described action produces controlled unbalanced action which generates lift.

It will be understood that the claims are intended to cover all changes and modifications of the preferred embodiments of the invention herein chosen for the purpose of illustration which do not constitute a departure from the spirit and scope of the invention. I claim:

1. A lift-providing unit comprising two weight units, at least one of which is capable of generating a recoil force, said two weight units being disposed at opposite ends of a rotating armature.

2. The lift-providing unit of claim 1 comprising an armature assembly mounted in a suspension housing to be rotatable around a center axis and a drive unit for applying a rotating force to said armature assembly to generate a centripetal force,
said armature assembly comprising an armature having a first weight assembly disposed at a first armature end and a second weight assembly disposed at an opposite second armature end; said first weight assembly and said second weight assembly each comprising:
a weight plate slidably mounted between an upper base plate and a lower base plate on at least one guiding shaft passing through a corresponding fenestration in said weight plate, a spring mounted concentric to said armature between said weight plate and said lower mounting plate,
a retracting coil for retracting said weight plate against the force of said spring and maintaining said weight plate in a retracted position until said coil is de-energized and, an opposing protracting coil for firing said weight plate in a direction opposite to said retracting, when said protracting coil is energized, and
a control device for selectively energizing and de-energizing each of said retracting coil and said protracting coil.

3. A vehicle comprising a platform attached to the lift-providing unit of claim 2.

4. The lift-providing unit of claim 1 wherein said control device includes a timing circuit and a sensing device for registering each rotation of said armature.

5. The lift-providing unit of claim 1 comprising an armature assembly mounted in a suspension housing to be rotatable around a center axis and a drive unit for applying a rotating force to said armature assembly to generate a centripetal force,
said armature assembly comprising an armature having a first weight assembly disposed at a first armature end and a second weight assembly disposed at an opposite second armature end; said first weight assembly acting as a lifting weight and comprising a weight plate slidably mounted between an upper base plate and a lower base plate on at least one guiding shaft which passes through a corresponding fenestration in said weight plate, and a spring mounted concentric to said armature between said weight plate and said lower mounting plate;
said second weight assembly acting as an equalizing weight assembly and comprising a weight plate slidably mounted between an upper base plate and a lower base plate on at least one guiding shaft which passes through a corresponding fenestration in said second weight plate,
said first weight assembly and said second weight assembly being attached by a bridging member having an elongated opening which allows said bridging member to slide along a central shaft,
said center axis comprising a cam which is substantially cylindrical but having a protrusion formed thereon, whereby, when said bridging member rotating around said central shaft strikes said protrusion a force is generated moving both said first weight assembly and said second weight assembly in the same direction, to generate a recoil force.

6. The unit of claim 5 wherein said cam comprises a cylinder supplied with at least one door assembly which can be opened by activating a door control device, to provide said protrusion.

7. The lift-providing unit of claim 1 comprising an armature assembly mounted in a suspension housing to be rotatable around a center axis and a drive unit for applying a rotating force to said armature assembly to generate a centripetal force,
said armature assembly comprising an armature having a first weight assembly disposed at a first armature end and a second weight assembly disposed at an opposite second armature end; said first weight assembly and said second weight assembly each comprising a weight plate slidably mounted between an upper base plate and a lower base plate on at least one guiding shaft which passes through a corresponding fenestration in said weight plate, said weight plate being mounted to an air cylinder provided with air valves adapted to allow compressed air into said cylinders and vent compressed air from said cylinders,
said center axis comprising a cam having a notched section and, on an opposite side thereof, a serrated area whereby, when a pushrod strikes said notched area, a top valve opens at a top half of a cylinder attached to said first weight assembly letting in compressed air and simultaneously, a bottom valve opens venting compressed air from a cylinder at a top position attached to said second weight assembly to impinge a force against said first weight assembly and release a force from said second weight assembly.

8. A lift unit for levitating a platform, the lift unit comprising:
(a) an armature assembly mounted in a suspension housing on the platform to be rotated about a central axis, wherein the armature assembly comprises at least one electrically conductive elongated tube with a fixed insulated solenoid plunger at either end thereof; and
(b) a drive unit for supplying a rotating force to the armature assembly to generate a centripetal force, wherein the drive unit comprises a weighted solenoid coil slidably mounted on the armature assembly to produce vertical movement of the platform by rotating the armature about the center axis.

9. A lift unit for levitating a platform, the lift unit comprising:
(a) a plurality of elongated coil bracket assemblies mounted equidistantly on a center rotor;
(b) a solenoid plunger slidably disposed in the armature assembly for movement towards and away from an axis of rotation about the center rotor;
(c) a set of guide tubes disposed in a spaced apart and parallel relationship to each other in the armature assembly between the solenoid coils for guiding the solenoid plunger during movement;
(d) a plurality of solenoid coils disposed in a spaced apart and parallel relation to each other in the coil bracket assembly perpendicular to the solenoid plunger for propelling the solenoid plunger; and
(e) a mounting member for mounting the center rotor to a platform.

10. The lift unit of claim 9 further comprising:
a plurality of buffer members in a spaced apart relation to each other for impacting the solenoid plunger, wherein each buffer member is disposed at opposite sides of the elongated coil bracket assembly.

11. The lift unit of claim 10 further comprising:
a spring disposed on the center buffer located closest to the axis of rotation for balancing the solenoid plungers during start-up.

12. The lift unit of claim 9 wherein the number of armature assemblies is an even integer.

13. The lift t unit of claim 12 wherein the number of armature assemblies is at least 2.

14. The lift unit of claim 9 wherein the number of solenoid coils is from 1 to 10.

15. The lift unit of claim 14 wherein the number of solenoid coils is from 2 to 8.

16. The lift unit of claim 15 wherein the number of solenoid coils is 3.

17. The lift unit of claim 9 wherein the guide tubes are non-magnetic.

19. The lift unit of claim 9 wherein the armature assembly is rotated counter-clockwise.

20. The lift unit of claim 9 wherein the armature assembly is rotated counter-clockwise.

21. A lift-providing unit comprising:
(a) a frame and a rotatable axle attached to said frame;
(b) a motor attached to said frame and connected to said axle for rotating said axle;
(c) a plurality of weight units attached to said axle, said plurality of weight units radiating out from said axle and being positioned equiangular about said axle, at least one of said weight units having a plunger which is movable between a first position which is near said axle and a second position which is away from said axle; and
(d) a means for moving said plunger between said second position and said first position such that movement of said plunger between said second position and said first position as said weight units rotate about said axle generates a lift.

22. The lift-providing unit of claim 21 wherein said plurality of weight units is four weight units.

23. The lift-providing unit of claim 21 wherein each of said weight units has a plunger which moves between said first and second position.

24. The lift-providing unit of claim 21 wherein each of said weight units comprises:
(a) an elongated member radially attached to said axle, said elongated member having a stopper member at each end; and
(b) said plunger positioned in said elongated member and movable between said stopper members such that one stopper member is positioned at said first position and the other stopper member is positioned at said second position.

25. The lift-providing unit of claim 21 wherein said means for moving said plunger is:
(a) solenoid coil which is positioned in said weight units such that said plunger moves inside said coil; and
(b) means for providing electrical current to said solenoid coil, said plunger being a solenoid plunger such that when electrical current is provided to said solenoid coil said solenoid plunger moves from said second position to said first position and when said electrical current is removed from said solenoid coil said solenoid plunger moves between said first position to said second position due to rotation of said weight unit about said axle.

26. A vehicle comprising a platform and the lift-providing unit of claim 21 wherein said frame is attached to said platform.
